(19) United States
(12) Patent Application Publication
(10) Pub. No.: US 2011/0252975 A1
(43) Pub. Date: Oct. 20, 2011

(54) BAFFLE DESIGN FOR AN AIR ELIMINATOR

(76) Inventor: Norman Seatter, Slave Lake (CA)

(21) Appl. No.: 13/089,200

(22) Filed: Apr. 18, 2011

Related U.S. Application Data
(60) Provisional application No. 61/325,845, filed on Apr. 20, 2010.

(51) Int. Cl. B01D 19/00

(52) U.S. Cl. 96/206

(57) ABSTRACT

An air eliminator has a housing with an inlet and an outlet. The inlet injects fluid into the housing along an inlet flow path that has a horizontal component. There is a baffle within the housing between the inlet and the outlet. The baffle has a vertical portion and a cover portion that extends outward from the vertical portion to cover at least a portion of the inlet flow path. The cover portion defines a flow path for buoyant fluid that has a vertical component and a horizontal component that is perpendicular to the inlet flow path up.

### FIELD

This relates to a baffle design for an air eliminator

### BACKGROUND

Air or other gases in a liquid stream can cause problems with flow metering, pumping equipment, etc. Air eliminators are used in liquid systems to aid in the removal of air or other gases from a liquid stream.

### SUMMARY

There is provided an air eliminator comprising a housing with an inlet and an outlet. The inlet injects fluid into the housing along an inlet flow path that has a horizontal component. There is a baffle within the housing between the inlet and the outlet. The baffle comprises a vertical portion and a cover portion that extends outward from the vertical portion to cover at least a portion of the inlet flow path. The cover portion defines a flow path for buoyant fluid that has a vertical component and a horizontal component that is perpendicular to the inlet flow path up.

According to another aspect, the cover portion may have a leading edge toward the inlet flow path, a trailing edge attached to the vertical portion, a first side edge and a second side edge, wherein the leading edge is vertically lower than the trailing edge, and the first side edge is vertically lower than the second side edge. The second side edge may be spaced from an inner surface of the housing to allow buoyant fluid to escape from under the cover portion.

According to another aspect, there may be a second cover portion that extends outward from the vertical portion toward the outlet of the housing. The second cover portion may be a mirror image of the cover portion.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view in section of the air eliminator. FIG. 2 is a front elevation view in section of the air eliminator. FIG. 3 is a perspective view of the baffle of the air eliminator.

### DETAILED DESCRIPTION

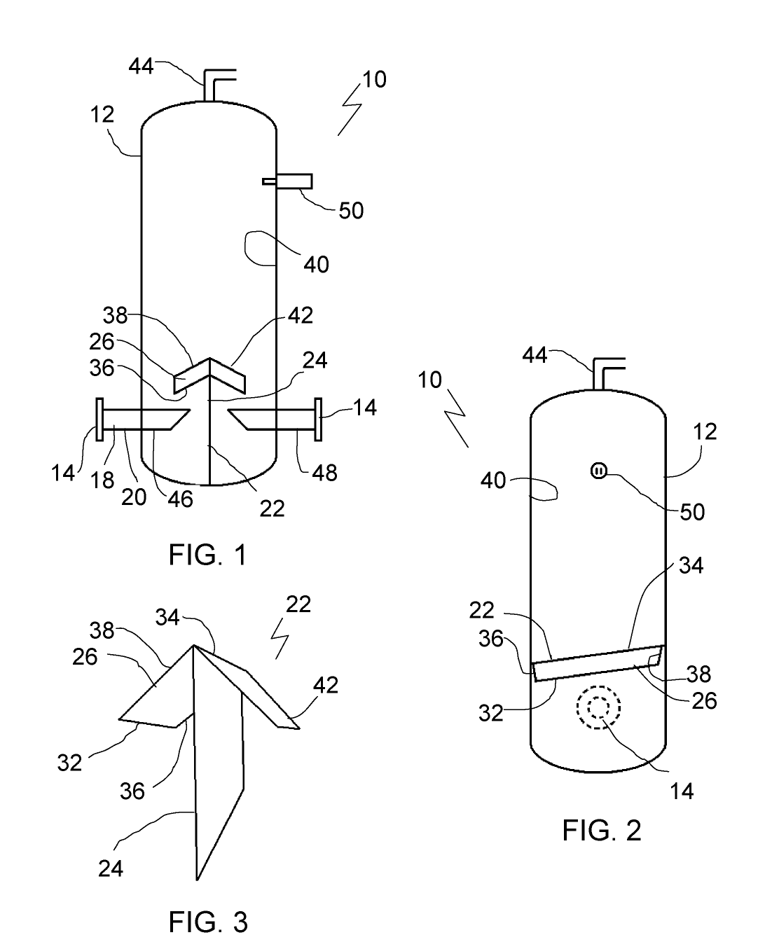

An air eliminator, generally identified by reference numeral 10, will now be described with reference to FIGS. 1 through 3.

### Structure and Relationship of Parts:

Referring to FIG. 1, air eliminator 10 includes a housing 12 with an inlet 14 and an outlet 16. Inlet 14 injects fluid into housing 12 along an inlet flow path 18 that has a horizontal component 20. A baffle 22 within housing 12 is positioned between inlet 12 and outlet 14. Housing 12 is intended to be coupled into a fluid line that is having fluid pumped through it to remove the gases.

Referring to FIG. 1, baffle 22 includes a vertical portion 24 and a cover portion 26 that extends outward from vertical portion 24 to cover at least a portion of the inlet flow path 18. Referring to FIG. 3, cover portion 26 defines a flow path for buoyant fluid (such as gas in a liquid) that has vertical and horizontal components that are perpendicular to inlet flow path 18. As shown, this is done by sloping cover portion 26 from side to side, as well as downward toward inlet 14. As shown, cover portion 26 has a leading edge 32 toward inlet flow path 18 which is vertically lower than a trailing edge 34 attached to vertical portion 24. A first side edge 36 of cover portion 26 is vertically lower than a second side edge 38 of cover portion 26. As fluid flows into housing 12, the flow is directed toward vertical portion 24 under cover portion 26. At least some gas that is entrained in the liquid will be captured either against baffle 22 as it adsorbs to the surface, or by the flow path defined by cover portion 26 as the gas moves upward. Referring to FIG. 2, second side edge 38 is spaced from inner surface 40 of housing 12 to allow buoyant fluid to escape from under cover portion 26 of baffle 22. Thus, as gas moves upward, it is directed toward second side edge 38 and allowed to escape to the top of housing 12 and toward gas outlet 44. A proximity switch 50 is provided that triggers a valve (not shown) to remove gas from housing 12 when necessary. The procedures used to dispose of the gas will depend on the type of gas and the fluid being pumped.

While cover portion 26 is shown as a flat piece directly attached to the top edge of vertical portion 24, it will be understood that other designs may also be possible that create a flow path for buoyant fluid under cover portion 26. For example, cover portion 26 may be curved, or may be “twisted” such that trailing edge 34 has a grater slope that leading edge 32.

In a preferred embodiment, there is a second cover portion 42 that extends outward from vertical portion 24 of baffle 22 toward outlet 16 of housing 12. As shown, second cover portion 42 is a mirror image of cover portion 26. This increases the flow path of the fluid to permit additional time for the gas to leave the liquid, but also allows the roles of inlet 14 and outlet 16 may be reversed, such that fluid may be pumped through housing 12 in either direction.

As shown, both inlet 14 and outlet 16 preferably have physical passageways 46 and 48 that extend under cover portion 26 and second cover portion 42, respectively. This ensures that the flow path of fluid through housing 12 is longer, as the fluid is only injected under cover portion 26, and withdrawn only from under second cover portion 42.

The sizes and dimensions of the various components, such as housing 12, inlet 14, outlet 16 and baffle 22, will depend on various factors, such as the fluid to be pumped, the flow rate, the anticipated gas content, etc.

### Operation:

A fluid is injected into housing 12 of air eliminator 10 along inlet flow path 18 by inlet 14, and exits housing 12 via outlet 16. Fluid must travel around baffle 22 in order to do so. As fluid contacts baffle 22, cover portion 26 of baffle 22 captures air bubbles in the fluid, or air adsorbs to the surface of baffle 22. The captured gas moves upward along baffle 22 toward second side edge 38, where it is permitted to flow to the top of housing 12. The remaining fluid then flow towards outlet 16 by going over and around cover portion 26 and then under second cover portion 40 of baffle 22, which allows the release of additional air bubbles from the fluid before leaving through outlet 16.

A flow path defined by cover portion 26 allows the buoyant air to flow off of baffle 22. Buoyant air moves vertically upwards along cover portion 26 toward trailing edge 34 and away from leading edge 32. Air also moves vertically upwards toward second side edge 38 of cover portion 26 and away from first side edge 36. Air moves off of baffle 22 by flowing off second side edge 38 which is spaced from inner surface 40 of housing 12.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. An air eliminator, comprising:
a housing having an inlet and an outlet, the inlet injecting fluid into the housing along an inlet flow path that has a horizontal component;
a baffle within the housing between the inlet and the outlet, the baffle comprising a vertical portion and a cover portion that extends outward from the vertical portion to cover at least a portion of the inlet flow path, the cover portion defining a flow path for buoyant fluid that has a vertical component and a horizontal component that is perpendicular to the inlet flow path up.

2. The air eliminator of claim 1, wherein the cover portion has a leading edge toward the inlet flow path, a trailing edge attached to the vertical portion, a first side edge and a second side edge, wherein the leading edge is vertically lower than the trailing edge, and the first side edge is vertically lower than the second side edge.

3. The air eliminator of claim 2, wherein the second side edge is spaced from an inner surface of the housing to allow buoyant fluid to escape from under the cover portion.

4. The air eliminator of claim 1, further comprising a second cover portion that extends outward from the vertical portion toward the outlet of the housing.

5. The air eliminator of claim 4, wherein the second cover portion is a mirror image of the cover portion.
